(19) United States
(12) Patent Application Publication
(10) Pub. No.: US 2009/0296973 A1
(43) Pub. Date: Dec. 3, 2009

(54) ELECTRONIC DEVICE WITH MICROPHONE MODULE CAPABLE OF BEING EFFICIENTLY AND CORRECTLY MOUNTED THEREIN AND PROCESS FOR ASSEMBLING THE SAME

(75) Inventors: Chih Ming Hsu, Taipei County (TW); Yu-De Tsai, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/128,711

(22) Filed: May 29, 2008

(51) Int. Cl. H04R 1/02

(52) U.S. Cl. 381/365

(57) ABSTRACT

An electronic device is provided, which includes a first cover, a second cover, a circuit board, and a first microphone. The first cover comprises a first wall portion, a first storage space encircled by the first wall portion, and a first acoustic opening connected to the first storage space. The circuit board is affixed to the second cover. The first microphone is mounted on the circuit board and disposed in the first storage space to receive external sound through the first acoustic opening.

### BACKGROUND OF THE INVENTION

1. Field of the Invention

The invention relates to an electronic device and a process for assembling the electronic device, and more particularly to an electronic device with a microphone module capable of being efficiently and correctly mounted therein, and a process for assembling the electronic device.

2. Description of the Related Art

Referring to FIG. 1, a conventional notebook computer 10 includes a main body 12 and a display 18. A keyboard 120 is provided on the main body 12 for inputting data or commands. The display 18 is rotatably connected to the main body 12 for presentation of visual information.

Referring to FIGS. 2A and 2B, the display 18 includes a rear cover 16, a front cover 14 affixed to the rear cover 16, and a microphone module 11 affixed to the front cover 14. The microphone module 11 includes a circuit board 17 and two microphones 15 and 15′ mounted on the circuit board 17. The front cover 14 has a first wall portion 144, a first storage space 148 encircled by the first wall portion 144, a second wall portion 144′, a second storage space 148′ encircled by the second wall portion 144′, a first acoustic opening 142 connected to the first storage space 148, and a second acoustic opening 142′ connected to the second storage space 148′.

To assemble the display 18, the microphones 15 and 15′ are fitted into two rubber holders 19 and 19′ (as indicated by arrow A), the microphone module 11 is mounted on the front cover 14 (as indicated by arrow B) by squeezing the rubber holders 19 and 19′ into the first and second storage spaces 148 and 148′, and then the front cover 14 and the rear cover 16 are connected.

In operation, the microphones 15 and 15′ constitute a microphone array, receiving external sound through the first and second acoustic openings 142 and 142′ of the front cover 14 of the display 18. The rubber holder 19 (19′) is provided for guaranteeing an airtight fit between the microphone 15 (15′) and the wall portion 144 (144′) so that the microphone 15 (15′) receives external sound only through the acoustic opening 142 (142′) of the front cover 14. During the assembly of the display 18, however, the microphone module 11 may not be correctly mounted on the front cover 14 by mistake (e.g. the microphone 15 (15′) and the rubber holder 19 (19′) may not completely disposed in the storage space 148 (148′)) or may be accidentally separated from the front cover 14. For such described situations, remounting of the microphone module 11 on the front cover 14 would be required, to assure an airtight fit between the microphone 15 (15′) and the wall portion 144 (144′). If such an event should occur, manufacturing efficiency would decrease.

### BRIEF SUMMARY OF THE INVENTION

The invention provides an electronic device with a microphone module capable of being efficiently and correctly mounted therein. The electronic device in accordance with an exemplary embodiment of the invention includes a first cover, a second cover, a circuit board, and a first microphone. The first cover comprises a first wall portion, a first storage space encircled by the first wall portion, and a first acoustic opening connected to the first storage space. The circuit board is affixed to the second cover. The first microphone is mounted on the circuit board and disposed in the first storage space to receive external sound through the first acoustic opening.

In another exemplary embodiment, the electronic device further comprises a second microphone mounted on the circuit board, wherein the first cover further comprises a second wall portion, a second storage space encircled by the second wall portion, and a second acoustic opening connected to the second storage space, and the second microphone is disposed in the second storage space and receives external sound through the second acoustic opening.

In yet another exemplary embodiment, the first microphone and the second microphone together, constitute a microphone array.

In another exemplary embodiment, the electronic device further comprises a first flexible holder and a second flexible holder respectively disposed in the first storage space and the second storage space, wherein the first microphone and the second microphone are respectively disposed in the first flexible holder and the second flexible holder.

In yet another exemplary embodiment, the first cover further comprises a first platform and a second platform respectively disposed in the first storage space and the second storage space, wherein the first flexible holder and the second flexible holder are respectively in contact with the first platform and the second platform.

In another exemplary embodiment, the first platform and the second platform have flat top surfaces contacting the first flexible holder and the second flexible holder, respectively.

In yet another exemplary embodiment, the second cover has a pair of grooved bars holding the circuit board.

In another exemplary embodiment, the second cover has a plurality of hooks engaging the circuit board.

In yet another exemplary embodiment, the second cover has a positioning element, and the circuit board contacts the positioning element to be positioned.

In another exemplary embodiment, the electronic device further comprises a screw which connects the first cover and the second cover, wherein the positioning element is inner threaded to receive the screw.

In yet another exemplary embodiment, the electronic device is a notebook computer.

In another exemplary embodiment, the electronic device is a cellular phone.

In yet another exemplary embodiment, the electronic device is an ultra mobile personal computer.

In another exemplary embodiment, the electronic device is a handheld device.

In yet another exemplary embodiment, the electronic device is a displaying device.

In another exemplary embodiment, the electronic device is a handset of a telephone.

In yet another exemplary embodiment, the electronic device is an answering machine.

In another exemplary embodiment, the electronic device is a hearing aid.

In yet another exemplary embodiment, the electronic device is a rearview mirror of a vehicle.

The invention also provides a process for assembling an electronic device. The process in accordance with an exemplary embodiment of the invention comprises the steps of: first, providing a first cover which has a storage space; second, providing a microphone module which has a circuit board and a microphone mounted on the circuit board; third, affixing the microphone module to a second cover; and fourth, connecting the first cover to the second cover, with the microphone disposed in the storage space.

In another exemplary embodiment, the process further comprises the step of fitting the microphone into a flexible holder before connecting the first cover to the second cover.

In yet another exemplary embodiment, the microphone module is positioned by a positioning element when affixed to the second cover.

The invention also provides another process for assembling an electronic device. The process in accordance with an exemplary embodiment of the invention comprises the steps of: first, providing a first cover which has a first storage space and a second storage space; second, providing a microphone module which has a circuit board, a first microphone mounted on the circuit board, and a second microphone also mounted on the circuit board; third, affixing the microphone module to a second cover; fourth, connecting the first cover to the second cover, with the first and second microphones respectively disposed in the first and second storage spaces.

In another exemplary embodiment, the process further comprises the step of fitting the first microphone into a first flexible holder before connecting the first cover to the second cover.

In yet another exemplary embodiment, the process further comprises the step of fitting the second microphone into a second flexible holder before connecting the first cover to the second cover.

In another exemplary embodiment, the microphone module is positioned by a positioning element when affixed to the second cover.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective diagram of a conventional notebook computer;

FIG. 2A is a IIA-IIA sectional view of the display of the conventional notebook computer of FIG. 1;

FIG. 2B is an exploded view of the display of the conventional notebook computer of FIG. 2A;

FIG. 3A is a perspective diagram of a notebook computer in accordance with a first embodiment of the invention;

FIG. 3B is a IIIB-IIIB sectional view of the display of the notebook computer of FIG. 3A;

FIG. 4A is a sectional view of a first cover of the display of FIG. 3B;

FIG. 4B is a perspective diagram of the first cover of the display of FIG. 3B;

FIG. 5A is a sectional view of a microphone module and a second cover of the display of FIG. 3B;

FIG. 5B is a perspective diagram of the microphone module and the second cover of the display of FIG. 3B;

FIG. 6 is an exploded sectional view of the display of a notebook computer in accordance with a second embodiment of the invention;

FIG. 7A is a perspective diagram of a notebook computer in accordance with a third embodiment of the invention;

FIG. 7B is a VIIB-VIIB sectional view of the display of the notebook computer of FIG. 7A;

FIG. 8A is a sectional view of a first cover of the display of FIG. 7B;

FIG. 8B is a perspective diagram of the first cover of the display of FIG. 7B;

FIG. 9A is a sectional view of a microphone module and a second cover of the display of FIG. 7B; and

FIG. 9B is a perspective diagram of the microphone module and the second cover of the display of FIG. 7B.

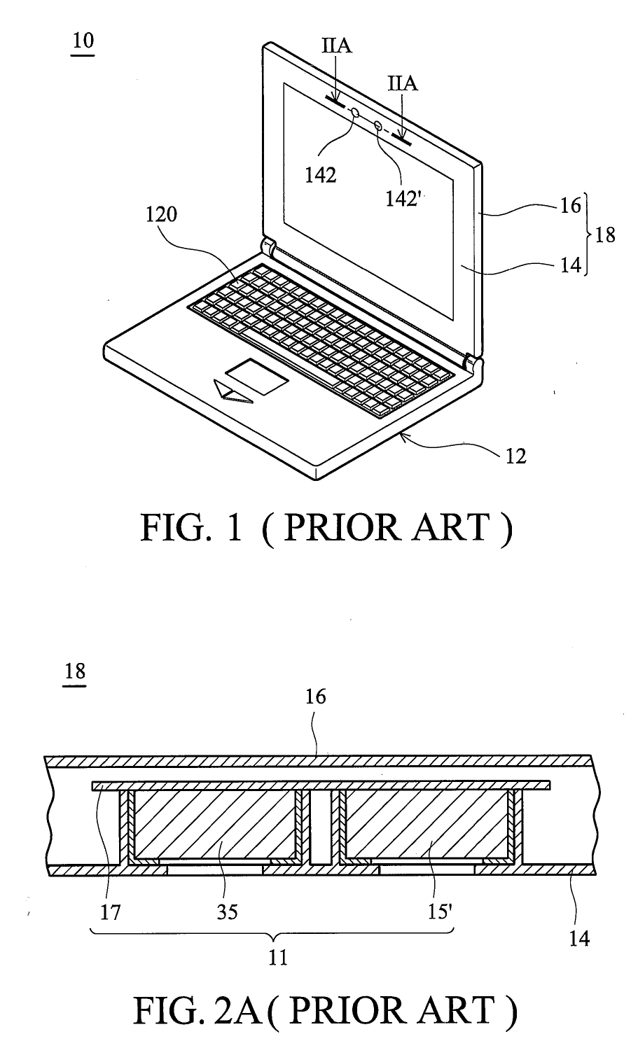

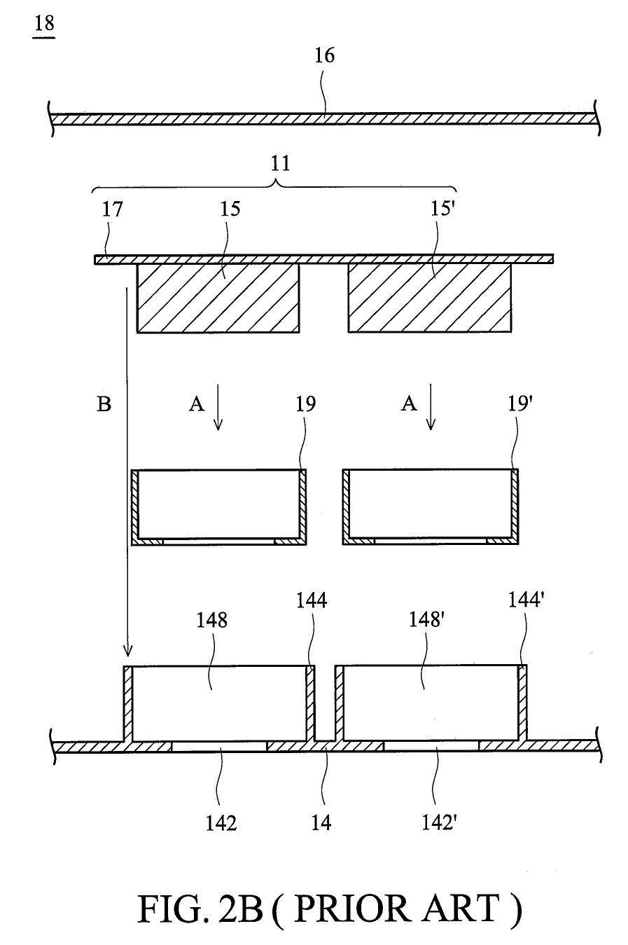

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

While a notebook computer is utilized for purposes of illustration, it is understood that the invention is equally applicable to a variety of electronic devices including a cellular phone, an ultra mobile personal computer, a handheld device, a displaying device, a handset of a telephone, an answering machine, a hearing aid, or a rearview mirror of a vehicle, and others.

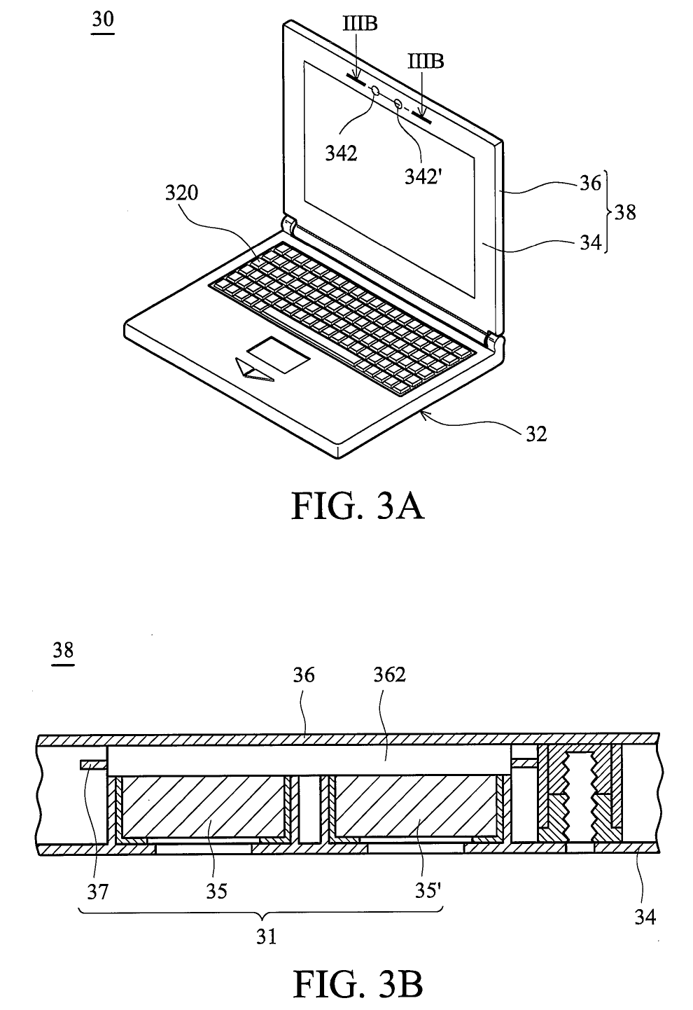

Referring to FIG. 3A, a notebook computer 30 of a first embodiment of the invention includes a main body 32 and a display 38. A keyboard 320 is provided on the main body 32 for inputting data or commands. The display 38 is rotatably connected to the main body 32 for presentation of visual information.

Referring to FIG. 3B, the display 38 includes a first cover 34, a second cover 36 connected to the first cover 34, and a microphone module 31 affixed to the second cover 36. The microphone module 31 includes a circuit board 37, a first microphone 35, and a second microphone 35′, wherein the first microphone 35 and the second microphone 35′ are mounted on the circuit board 37.

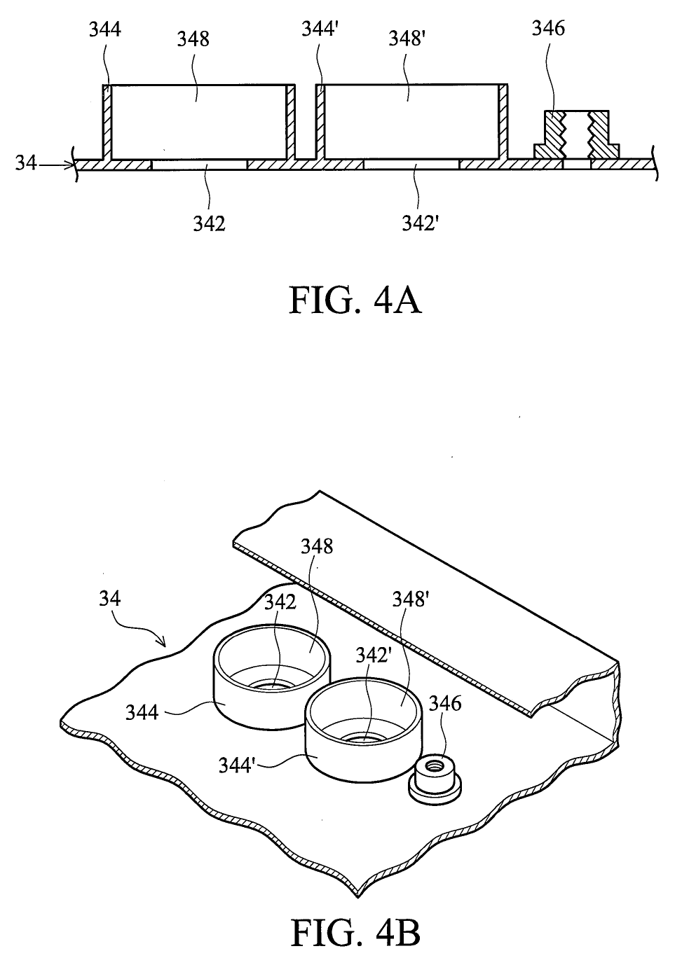

Referring to FIGS. 4A and 4B, the first cover 34 has a first wall portion 344, a first storage space 348 encircled by the first wall portion 344, a second wall portion 344′, a second storage space 348′ encircled by the second wall portion 344′, a first acoustic opening 342 connected to the first storage space 348, a second acoustic opening 342′ connected to the second storage space 348′, and a connecting post 346.

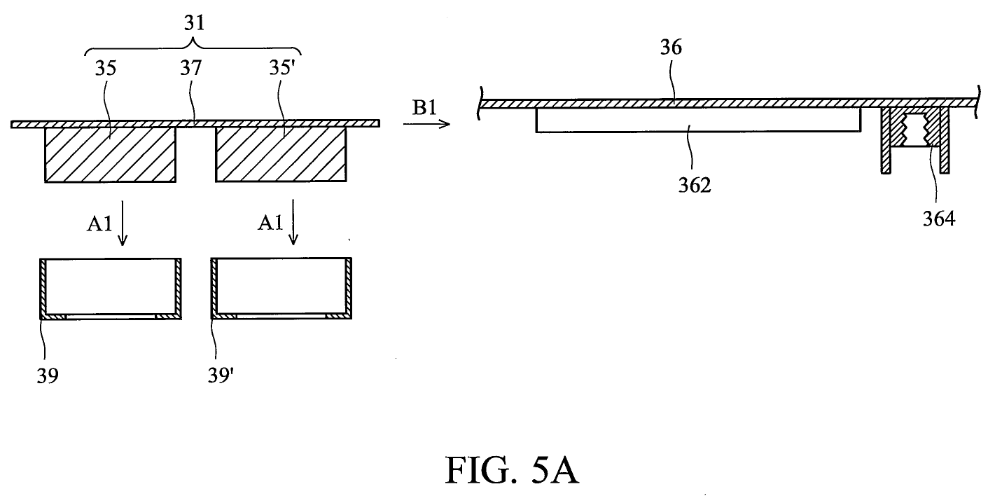

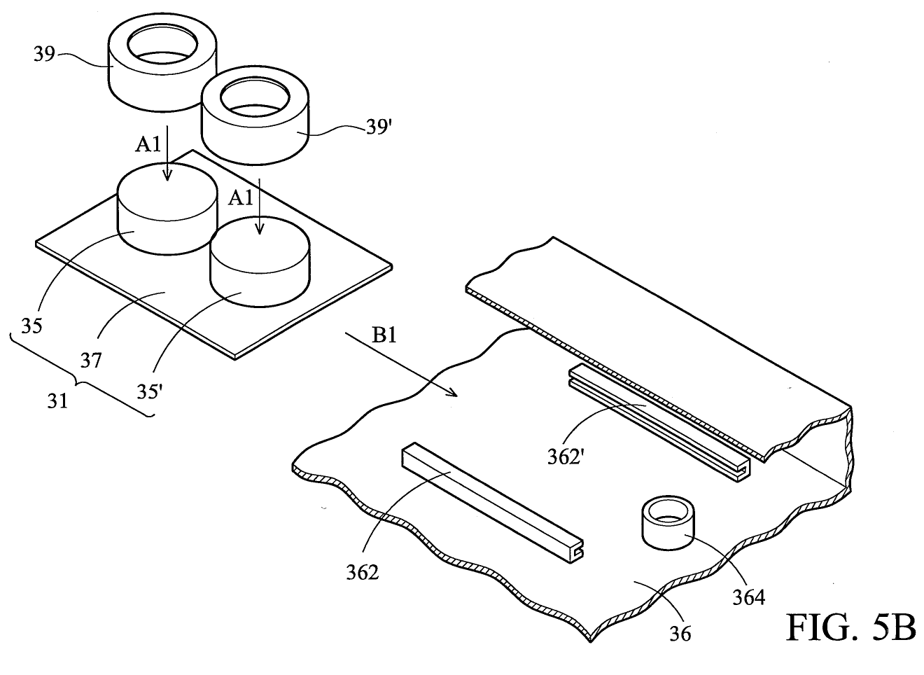

Referring to FIGS. 5A and 5B, the second cover 36 has a pair of parallel grooved bars 362 and 362′, and a positioning element 364. In assembly, the first microphone 35 and the second microphone 35′ are fitted into a first flexible holder 39 and a second flexible holder 39′, respectively (as indicated by arrows A1). The microphone module 31 is pushed to slide along the grooved bars 362 and 362′ (as indicated by arrow B1) until contacting the positioning element 364. Thus, the microphone module 31 is affixed to the second cover 36 and correctly positioned. Then, the first cover 34 and the second cover 36 are connected and fixed through screws (not shown), with the first flexible holder 39 and the second flexible holder 39′ of the microphone module 31 squeezed into the first and second storage spaces 348 and 348′ of the first cover 34. The connecting post 346 of the first cover 34 and the positioning element 364 of the second cover 36 are inner threaded to receive the screw.

In operation, the first microphone 35 and the second microphone 35′ constitute a microphone array, receiving external sound through the first and second acoustic openings 342 and 342′ of the first cover 34 of the display 38. In the first embodiment, the first flexible holder 39 is made of rubber, generating an airtight fit between the first microphone 35 and the first wall portion 344 so that the first microphone 35 can receive external sound only through the first acoustic opening 342 of the first cover 34. Similarly, the second flexible holder 39′ is made of rubber, generating an airtight fit between the second microphone 35′ and the second wall portion 344′ so that the second microphone 35′ can receive external sound only through the second acoustic opening 342′ of the first cover 34.

During assembly of the display 38, the microphone module 31 is firmly held by the grooved bars 362 and 362′ on the second cover 36 and correctly positioned by the positioning element 364. Thus, accidental separation of the microphone module 31 from the second cover 36 can be prevented. Additionally, requirement to remount the microphone module 31 on the second cover 36 can be avoided.

In the first embodiment, the first cover 34 and the second cover 36 are the front cover and the rear cover of the display 38, respectively.

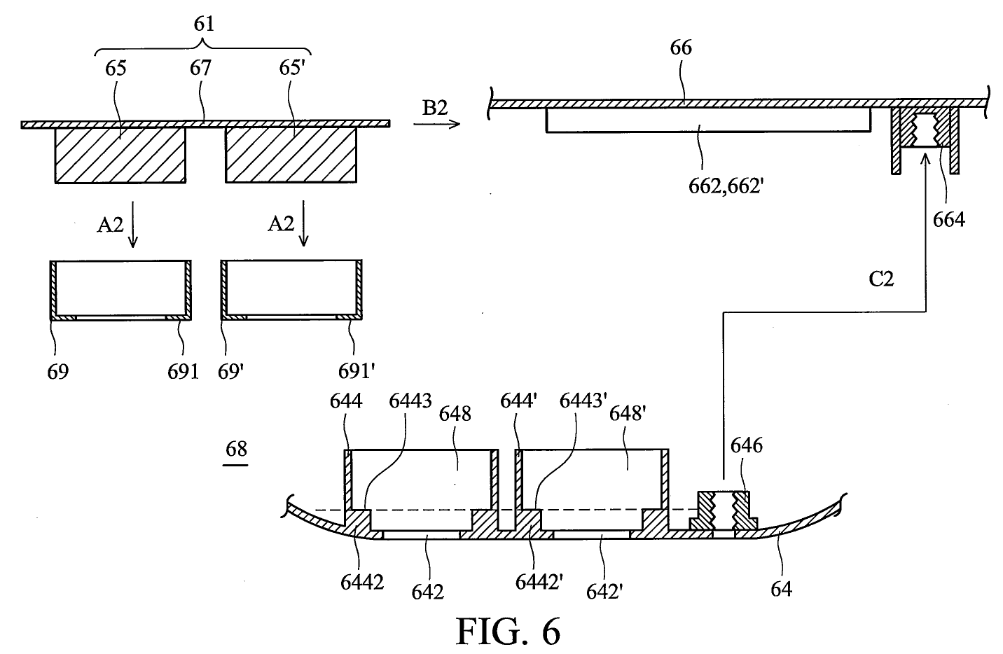

Referring to FIG. 6, a notebook computer of a second embodiment of the invention is provided with a display 68. The display 68 includes a first cover 64, a second cover 66, and a microphone module 61 affixed to the second cover 66. The microphone module 61 includes a circuit board 67, a first microphone 65, and a second microphone 65′, wherein the first microphone 65 and the second microphone 65′ are mounted on the circuit board 67.

The first cover 64 has a first wall portion 644, a first storage space 648 encircled by the first wall portion 644, a second wall portion 644′, a second storage space 648′ encircled by the second wall portion 644′, a first acoustic opening 642 connected to the first storage space 648, a second acoustic opening 642′ connected to the second storage space 648′, and a connecting post 646. The first wall portion 644 and the second wall portion 644′ have inner platforms 6442 and 6442′, respectively.

The second cover 66 has a pair of parallel grooved bars 662 and 662′, and a positioning element 664. In assembly, the first microphone 65 and the second microphone 65′ are fitted into a first flexible holder 69 and a second flexible holder 69′, respectively (as indicated by arrows A2). The microphone module 61 is pushed to slide along the grooved bars 662 and 662′ (as indicated by arrow B2) until contacting the positioning element 664. Thus, the microphone module 61 is affixed to the second cover 66 and correctly positioned. Then, the first cover 64 and the second cover 66 are connected and fixed through screws (not shown), with the first flexible holder 69 and the second flexible holder 69′ of the microphone module 61 squeezed into the first and second storage spaces 648 and 648′ of the first cover 64. The connecting post 646 of the first cover 64 and the positioning element 664 of the second cover 66 are inner threaded to receive the screw.

In operation, the first microphone 65 and the second microphone 65′ constitute a microphone array, receiving external sound through the first and second acoustic openings 642 and 642′ of the first cover 64 of the display 68.

In the second embodiment, the first cover 64 is slightly curved while the first and second flexible holders 69 and 69′ respectively have flat bottom surfaces 691 and 691′. To avoid any gaps therebetween, the platform 6442 provided in the first storage space 648 has a flat top surface 6443 which is capable of tightly contacting the first flexible holder 69. Similarly, the platform 6442′ provided in the second storage space 648′ has a flat top surface 6443′ to avoid any gaps between the curved first cover 64 and the flat bottom surface 691′ of the second flexible holder 69′.

During assembly of the display 68, the microphone module 61 is firmly held by the grooved bars 662 and 662′ on the second cover 66 and correctly positioned by the positioning element 664. Thus, accidental separation of the microphone module 61 from the second cover 66 can be prevented. Additionally, requirement to remount the microphone module 61 on the second cover 66 can be avoided.

In the second embodiment, the first cover 64 and the second cover 66 are the front cover and the rear cover of the display 68, respectively.

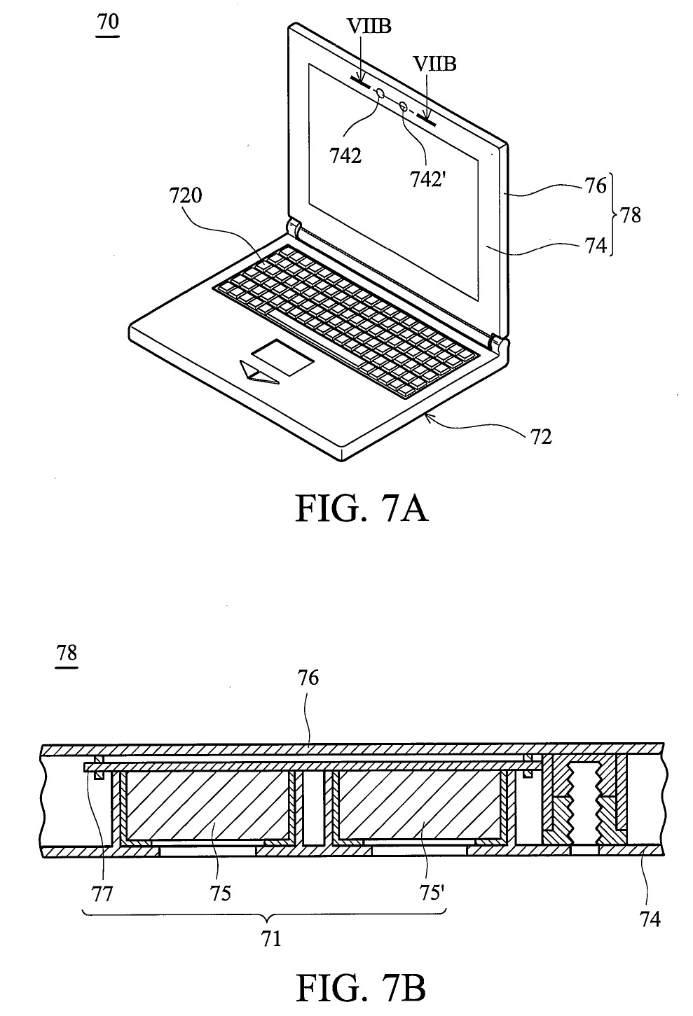

Referring to FIG. 7A, a notebook computer 70 of a third embodiment of the invention includes a main body 72 and a display 78. A keyboard 720 is provided on the main body 72 for inputting data or commands. The display 78 is rotatably connected to the main body 72 for presentation of visual information.

Referring to FIG. 7B, the display 78 includes a first cover 74, a second cover 76 connected to the first cover 74, and a microphone module 71 affixed to the second cover 76. The microphone module 71 includes a circuit board 77, a first microphone 75, and a second microphone 75′, wherein the first microphone 75 and the second microphone 75′ are mounted on the circuit board 77.

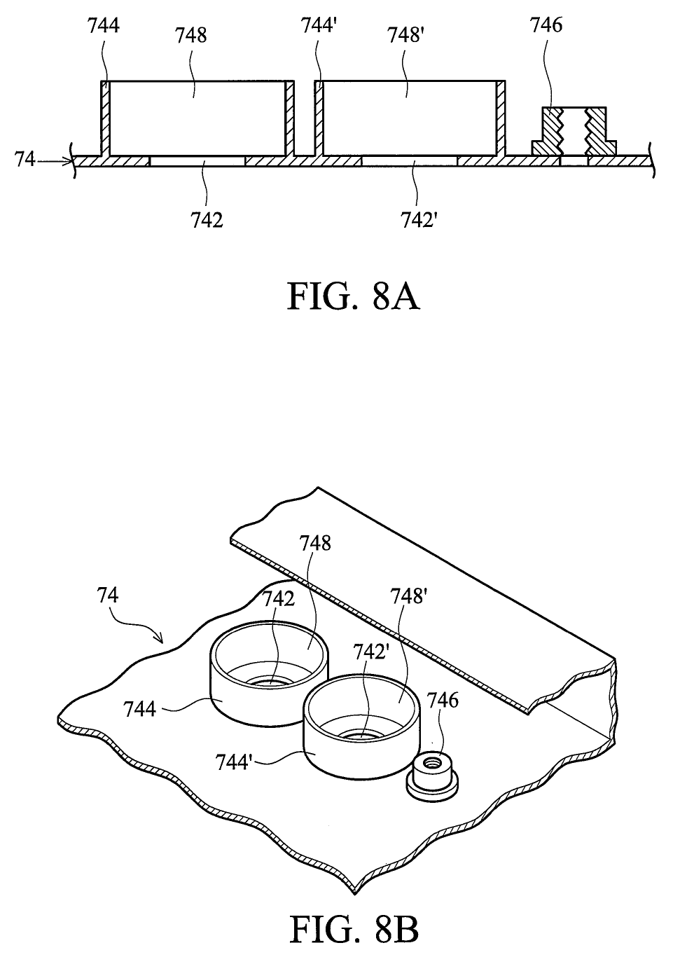

Referring to FIGS. 8A and 8B, the first cover 84 has a first wall portion 744, a first storage space 748 encircled by the first wall portion 744, a second wall portion 744′, a second storage space 748′ encircled by the second wall portion 744′, a first acoustic opening 742 connected to the first storage space 748, a second acoustic opening 742′ connected to the second storage space 748′, and a connecting post 746.

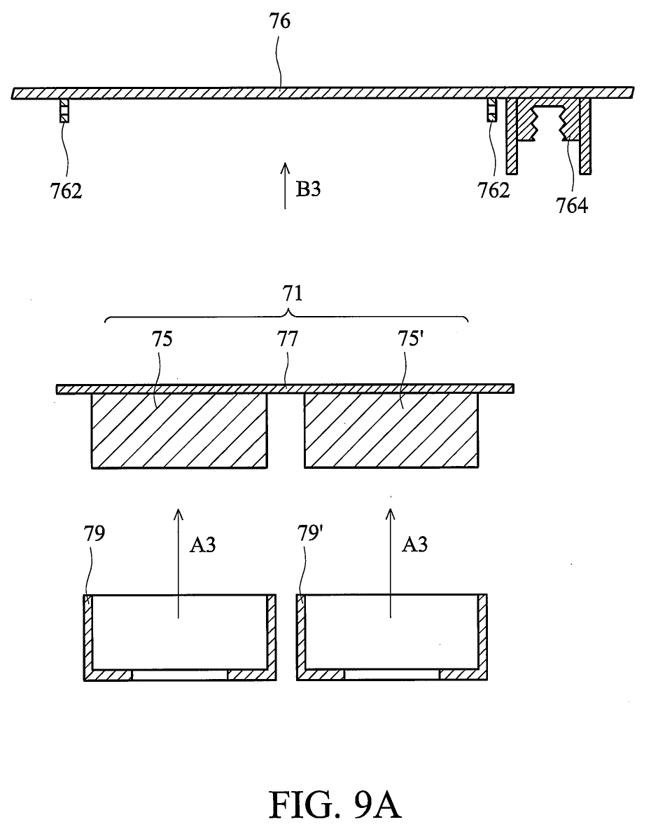

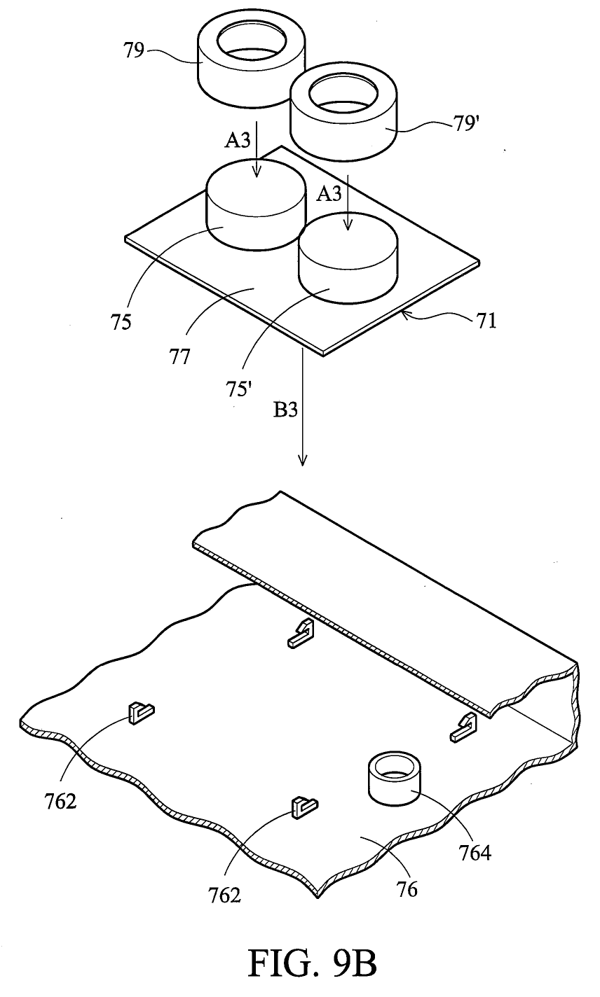

Referring to FIGS. 9A and 9B, the second cover 76 has a plurality of hooks 762, and a positioning element 764. In assembly, the first microphone 75 and the second microphone 75′ are fitted into a first flexible holder 79 and a second flexible holder 79′, respectively (as indicated by arrows A3). The microphone module 71 is pressed (as indicated by arrow B3) and affixed to the second cover 76 by the hooks 762, wherein an edge of the microphone module 71 contacts the positioning element 764. Thus, the microphone module 71 is affixed to the second cover 76 and correctly positioned. Then, the first cover 74 and the second cover 76 are connected and fixed through screws (not shown), with the first flexible holder 79 and the second flexible holder 79′ of the microphone module 71 squeezed into the first and second storage spaces 748 and 748′ of the first cover 74. The connecting post 746 of the first cover 74 and the positioning element 764 of the second cover 76 are inner threaded to receive the screw.

In operation, the first microphone 75 and the second microphone 75′ constitute a microphone array, receiving external sound through the first and second acoustic openings 742 and 742′ of the first cover 74 of the display 78. In the third embodiment, the first flexible holder 79 is made of rubber, generating an airtight fit between the first microphone 75 and the first wall portion 744 so that the first microphone 75 can receive external sound only through the first acoustic opening 742 of the first cover 74. Similarly, the second flexible holder 79′ is made of rubber, generating an airtight fit between the second microphone 75′ and the second wall portion 744′ so that the second microphone 75′ can receive external sound only through the second acoustic opening 742′ of the first cover 74.

During the assembly of the display 78, the microphone module 71 is firmly held by the grooved bars 762 and 762′ on the second cover 76 and correctly positioned by the positioning element 764. Thus, accidental separation of the microphone module 71 from the second cover 76 can be prevented. Additionally, requirement to remount the microphone module 71 on the second cover 76 can be avoided.

In the third embodiment, the first cover 74 and the second cover 76 are the front cover and the rear cover of the display 78, respectively.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a first cover comprising a first wall portion, a first storage space encircled by the first wall portion, and a first acoustic opening connected to the first storage space;
a second cover;
a circuit board affixed to the second cover; and
a first microphone mounted on the circuit board and disposed in the first storage space to receive external sound through the first acoustic opening.

2. The electronic device as claimed in claim 1, further comprising a second microphone mounted on the circuit board, wherein the first cover further comprises a second wall portion, a second storage space encircled by the second wall portion, and a second acoustic opening connected to the second storage space, and the second microphone is disposed in the second storage space and receives external sound through the second acoustic opening.

3. The electronic device as claimed in claim 2, wherein the first microphone and the second microphone together, constitute a microphone array.

4. The electronic device as claimed in claim 2, further comprising a first flexible holder and a second flexible holder respectively disposed in the first storage space and the second storage space, wherein the first microphone and the second microphone are respectively disposed in the first flexible holder and the second flexible holder.

5. The electronic device as claimed in claim 4, wherein the first cover further comprises a first platform and a second platform respectively disposed in the first storage space and the second storage space, wherein the first flexible holder and the second flexible holder respectively contact the first platform and the second platform.

6. The electronic device as claimed in claim 5, wherein the first platform and the second platform have flat top surfaces contacting the first flexible holder and the second flexible holder, respectively.

7. The electronic device as claimed in claim 1, wherein the second cover has a pair of grooved bars holding the circuit board.

8. The electronic device as claimed in claim 1, wherein the second cover has a plurality of hooks engaging the circuit board.

9. The electronic device as claimed in claim 1, wherein the second cover has a positioning element, and the circuit board contacts the positioning element to be positioned.

10. The electronic device as claimed in claim 9, further comprising a screw which connects the first cover and the second cover, wherein the positioning element is inner threaded to receive the screw.

11. The electronic device as claimed in claim 1, wherein the electronic device is a notebook computer, a cellular phone, an ultra mobile personal computer, a handheld device, a displaying device, a handset of a telephone, an answering machine, a hearing aid, or a rearview mirror of a vehicle.

12. A process for assembling an electronic device, comprising:
providing a first cover which has a storage space;
providing a microphone module which has a circuit board and a microphone mounted on the circuit board;
affixing the microphone module to a second cover; and
connecting the first cover to the second cover, with the microphone disposed in the storage space.

13. The process as claimed in claim 12, further comprising fitting the microphone into a flexible holder before connecting the first cover to the second cover.

14. The process as claimed in claim 12, wherein the microphone module is positioned by a positioning element when affixed to the second cover.

15. A process for assembling an electronic device, comprising:
providing a first cover which has a first storage space and a second storage space;
providing a microphone module which has a circuit board, a first microphone mounted on the circuit board, and a second microphone also mounted on the circuit board;
affixing the microphone module to a second cover; and
connecting the first cover to the second cover, with the first and second microphones respectively disposed in the first and second storage spaces.

16. The process as claimed in claim 15, further comprising fitting the first microphone into a first flexible holder before connecting the first cover to the second cover.

17. The process as claimed in claim 16, further comprising fitting the second microphone into a second flexible holder before connecting the first cover to the second cover.

18. The process as claimed in claim 15, wherein the microphone module is positioned by a positioning element when affixed to the second cover.
